(19) United States
(12) Patent Application Publication
(10) Pub. No.: US 2018/0369706 A1
(43) Pub. Date: Dec. 27, 2018

(54) Three-Dimensional Toy Ultraviolet Fast Molding Environmental Protection Material and the Molding Craft Thereof

(71) Applicant: XIELE ELECTRONIC & PLASTIC LIMITED, Dongguan City (CN)

(72) Inventor: Xiu-Ying Yang, Dongguan City (CN)

(21) Appl. No.: 15/632,434

(22) Filed: Jun. 26, 2017

(51) Int. Cl. A63H 33/00; B29C 39/26; G02F 1/01

(52) U.S. Cl. CPC A63H 33/001; B29C 39/26; B29C 61/00; B29K 2995/0018; G02F 1/0147

(57) ABSTRACT

An environmental protection material structure includes aliphatic urethane acrylate with a proportion of 52-58%, photoinitiator with a proportion of 8-13%, gas phase silicon dioxide with a proportion of 3-6%, propylene glycol glycerin triacrylate with a proportion of 8-14%, and acrylate with a proportion of 23-36%. A method for molding a three-dimensional toy includes stirring the environmental protection material structure to form a gel and pouring the gel into a squeeze bottle, spreading the gel on a cavity of a light permeable mold, placing the mold into an ultraviolet lamp box and irradiating the mold to solidify the mold so as to form a product model, and opening the ultraviolet lamp box and removing the product model.

### BACKGROUND OF THE INVENTION

1. Field of the Invention

The present invention relates to environmental protection material for molding a three-dimensional toy and, more particularly, to three-dimensional toy ultraviolet fast molding environmental protection material and the molding craft thereof.

2. Description of the Related Art

A conventional three-dimensional toy; such as a plasticine, a color clay, a sandy clay and the like, has a soft feature and is made to have various shapes, thereby providing an amusement effect to the children, and thereby enhancing the handy skill of the children. However, the conventional three-dimensional toy is dried very slowly, thereby wasting the shaping time. In addition, the conventional three-dimensional toy is cured at a high energy, thereby wasting the energy. Further, the conventional three-dimensional toy produces great odor, and easily excites the user's skin, thereby causing danger to the user. Further, the conventional three-dimensional toy is not made of environmental protection material.

### BRIEF SUMMARY OF THE INVENTION

The primary objective of the present invention is to provide an environmental protection material structure for molding a three-dimensional toy quickly by the ultraviolet light and a method for molding the three-dimensional toy.

In accordance with the present invention, there is provided an environmental protection material structure comprising aliphatic urethane acrylate with a proportion of 52-58%, photoinitiator with a proportion of 8-13%, gas phase silicon dioxide with a proportion of 3-6%, propylene glycol glycerin triacrylate with a proportion of 8-14%, and acrylate with a proportion of 23-36%.

In accordance with the present invention, there is provided a method for molding a three-dimensional toy comprising a first step of placing the environmental protection material structure into a container, evenly stirring the environmental protection material structure to form a gel and pouring the gel into a squeeze bottle, a second step of filling the gel into a light permeable mold with an upper die and a lower die and fully spreading the gel on a cavity of each of the upper die and the lower die of the light permeable mold, a third step of placing the mold with the gel into an ultraviolet lamp box and irradiating the mold to solidify the mold so as to form a product model of a three-dimensional toy, and a fourth step of opening the ultraviolet lamp box and removing the product model from the ultraviolet lamp box.

Preferably, in the third step, the ultraviolet lamp box has a power of 0.1-5 W, and has an irradiating and solidifying time of one to ten minutes (1-10 min).

Preferably, the second step, the third step and the fourth step are repeated one time according to a double-face requirement of the three-dimensional toy.

According to the primary advantage of the present invention, the gel has a short solidifying time (about 1-10 min), so that the gel is cured rapidly under a cold light of an LED, so as to mold the three-dimensional toy quickly.

According to another advantage of the present invention, the gel is solidified under the power of 0.1-5 W, so that the gel is cured at a low energy, thereby saving the energy.

According to a further advantage of the present invention, the user only needs to spread the gel on the light permeable mold so as to make the three-dimensional toy, so that the three-dimensional toy is made easily and simply, and the child can operate and make the three-dimensional toy independently.

According to a further advantage of the present invention, the gel produces little odor, and does not excite the user's skin so that the user can use the three-dimensional toy safely.

According to a further advantage of the present invention, the three-dimensional toy has an environmental protection feature by provision of the environmental protection material structure.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

Not applicable

### DETAILED DESCRIPTION OF THE INVENTION

An environmental protection material structure of the present invention comprises aliphatic urethane acrylate with a proportion of 52-58%, photoinitiator with a proportion of 8-13%, gas phase silicon dioxide with a proportion of 3-6%, propylene glycol glycerin triacrylate with a proportion of 8-14%, and acrylate with a proportion of 23-36%.

A method for molding a three-dimensional toy of the present invention comprises a first step of placing the environmental protection material structure into a container, evenly stirring the environmental protection material structure to form a gel and pouring the gel into a squeeze bottle, a second step of filling the gel into a light permeable mold with an upper die and a lower die and fully spreading the gel on a cavity of each of the upper die and the lower die of the light permeable mold, a third step of placing the mold with the gel into an ultraviolet lamp box and irradiating the mold to solidify the mold so as to form a product model of a three-dimensional toy, and a fourth step of opening the ultraviolet lamp box and removing the product model from the ultraviolet lamp box.

In the second step, the gel has a spreading thickness of 0.5-10 mm.

In the third step, the ultraviolet lamp box has a power of 0.1-5 W, and has an irradiating and solidifying time of one to ten minutes (1-10 min).

The second step, the third step and the fourth step are repeated one time according to a double-face requirement of the three-dimensional toy.

In the first preferred embodiment of the present invention, the environmental protection material structure includes aliphatic urethane acrylate with a proportion of 52%, photoinitiator with a proportion of 8%, gas phase silicon dioxide with a proportion of 3%, propylene glycol glycerin triacrylate with a proportion of 14%, and acrylate with a proportion of 23%.

In the second preferred embodiment of the present invention, the environmental protection material structure includes aliphatic urethane acrylate with a proportion of 50%, photoinitiator with a proportion of 10%, gas phase silicon dioxide with a proportion of 6%, propylene glycol glycerin triacrylate with a proportion of 8%, and acrylate with a proportion of 26%.

In the third preferred embodiment of the present invention, the environmental protection material structure includes aliphatic urethane acrylate with a proportion of 51%, photoinitiator with a proportion of 9%, gas phase silicon dioxide with a proportion of 5%, propylene glycol glycerin triacrylate with a proportion of 10%, and acrylate with a proportion of 25%.

Accordingly, the gel has a short solidifying time (about 1-10 min), so that the gel is cured rapidly under a cold light of an LED, so as to mold the three-dimensional toy quickly. In addition, the gel is solidified under the power of 0.1-5 W, so that the gel is cured at a low energy, thereby saving the energy. Further, the user only needs to spread the gel on the light permeable mold so as to make the three-dimensional toy, so that the three-dimensional toy is made easily and simply, and the child can operate and make the three-dimensional toy independently. Further, the gel produces little odor, and does not excite the user's skin so that the user can use the three-dimensional toy safely. Further, the three-dimensional toy has an environmental protection feature by provision of the environmental protection material structure.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. An environmental protection material structure comprising:
aliphatic urethane acrylate with a proportion of 52-58%;
photoinitiator with a proportion of 8-13%;
gas phase silicon dioxide with a proportion of 3-6%;
propylene glycol glycerin triacrylate with a proportion of 8-14%; and
acrylate with a proportion of 23-36%.

2. The environmental protection material structure of claim 1, wherein a method for molding a three-dimensional toy comprises:
a first step of placing the environmental protection material structure into a container, evenly stirring the environmental protection material structure to form a gel and pouring the gel into a squeeze bottle;
a second step of filling the gel into a light permeable mold with an upper die and a lower die and fully spreading the gel on a cavity of each of the upper die and the lower die of the light permeable mold;
a third step of placing the mold with the gel into an ultraviolet lamp box and irradiating the mold to solidify the mold so as to form a product model of a three-dimensional toy; and
a fourth step of opening the ultraviolet lamp box and removing the product model from the ultraviolet lamp box.

3. The environmental protection material structure of claim 2, wherein in the third step, the ultraviolet lamp box has a power of 0.1-5 W, and has an irradiating and solidifying time of one to ten minutes (1-10 min).

4. The environmental protection material structure of claim 2, wherein the second step, the third step and the fourth step are repeated one time according to a double-face requirement of the three-dimensional toy.
